(19) United States
(12) Patent Application Publication
(10) Pub. No.: US 2007/0040340 A1
(43) Pub. Date: Feb. 22, 2007

(54) Actuator, in particular for a chassis

(76) Inventor: Dirk Kesselgruber, Montabaur (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/496,964

(22) Filed: Aug. 1, 2006

Related U.S. Application Data
(63) Continuation of application No. PCT/EP05/00865, filed on Jan. 28, 2005.

(30) Foreign Application Priority Data
Feb. 3, 2004 (DE) 20 2004 001 614.1

(51) Int. Cl. B60G 17/005

(52) U.S. Cl. 280/5.502

(57) ABSTRACT

An actuator, in particular for an active chassis of a motor vehicle, comprising a first and a second toothed rack and a pinion which engages in the two toothed racks and is adapted to move the latter in directions opposite to one another.

### CROSS-REFERENCE TO RELATED APPLICATIONS

This application is a continuation of International Application No. PCT/EP2005/000865 filed Jan. 28, 2005, the disclosures of which are incorporated herein by reference in entirety, and which claimed priority to German Patent Application No. DE 20 2004 001 614.1 filed Feb. 3, 2004, the disclosures of which are incorporated herein by reference in entirety.

### BACKGROUND OF THE INVENTION

The invention relates to an actuator, in particular for an active chassis of a motor vehicle.

In modern chassis, actuators are more and more often used, by means of which an active influencing of the road behaviour may be achieved. One example is an active roll influencing which may for example be achieved by the tensioning of two components of an antiroll bar.

Both hydraulic as well as electromechanical actuators are known. One example for a hydraulic actuator is a positioning cylinder which is actuated with hydraulic fluid. The advantage of such a system is that the actuator is of a very small size, while at the same time having a high efficiency. That is attributable to the fact that the drive source, i.e. the hydraulic pump, may be separated in space from the actuator. Also known are electromechanical actuators, in particular linear drives. However, these linear drives require comparatively large construction spaces in the case of high power demands, because in their case the drive source, i.e. the electromotor, cannot be separated from the actuator proper.

### BRIEF SUMMARY OF THE INVENTION

It is a feature of the invention to provide an electromechanical actuator, in particular a linear drive, which is distinguished by a small construction space while having a high efficiency.

For this purpose there is provided for in accordance with the invention an actuator having a first and a second toothed rack as well as a pinion which engages in the two toothed racks and is adapted to move the latter in directions opposite to one another. This actuator is distinguished by a particularly small construction space, because by using two toothed racks moving in directions opposite to one another a doubling of the stroke compared to a simple toothed rack is achieved. This results in a lower construction space requirement, referring to the actuator stroke. The pinion may simultaneously be driven by an electrical drive motor that is separately arranged from the actuator and connected thereto via a drive shaft. Thus, the drive may be arranged angularly and spatially offset from the motor, which offers advantages with regard to the construction space required for the actuator proper.

Advantageous designs of the invention will be apparent from the sub-claims.

Other advantages of this invention will become apparent to those skilled in the art from the following detailed description of the preferred embodiment, when read in light of the accompanying drawings.

### BRIEF DESCRIPTION OF THE DRAWINGS

FIG. 1 shows a schematic view of an actuator in accordance with the invention having a drive motor; and

FIG. 2 shows a schematic view through the actuator of FIG. 1, with different operating states being illustrated.

### DETAILED DESCRIPTION OF THE INVENTION

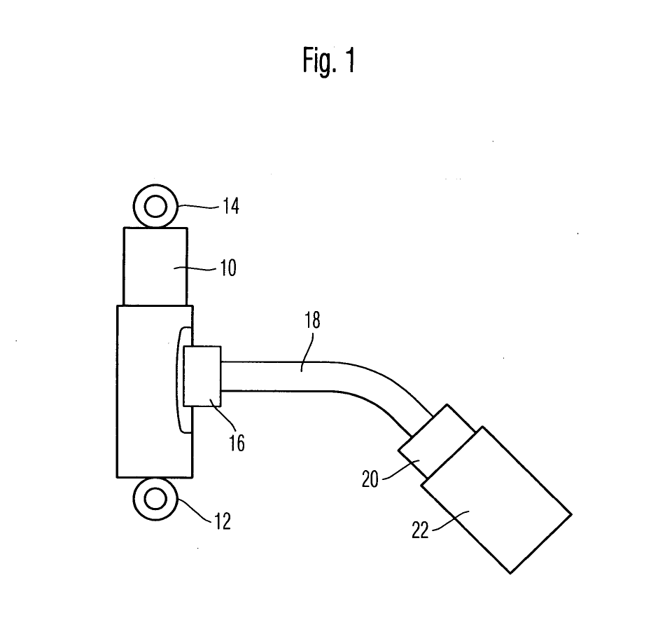

In FIG. 1 there can be seen an actuator 10 which comprises a first fastening eye 12 and a second fastening eye 14. When the actuator is used in an active chassis of a vehicle, the first fastening eye 12 may for example be attached to a suspension member of the chassis and the second fastening eye 14 may be attached to the vehicle body.

The actuator 10 comprises a drive pinion 16 by means of which a linear stroke of the actuator may be caused, i.e. a movement of the two fastening eyes 12, 14 towards or away from each other. The drive pinion 16 communicates via a drive shaft 18 and a gear 20 with a drive motor 22. The drive shaft 18 may be a propeller shaft or a flexible shaft so that the drive motor 22 may be accommodated at a distance of the actuator at a suitable location in the vehicle, in particular at a location where sufficient construction space is available.

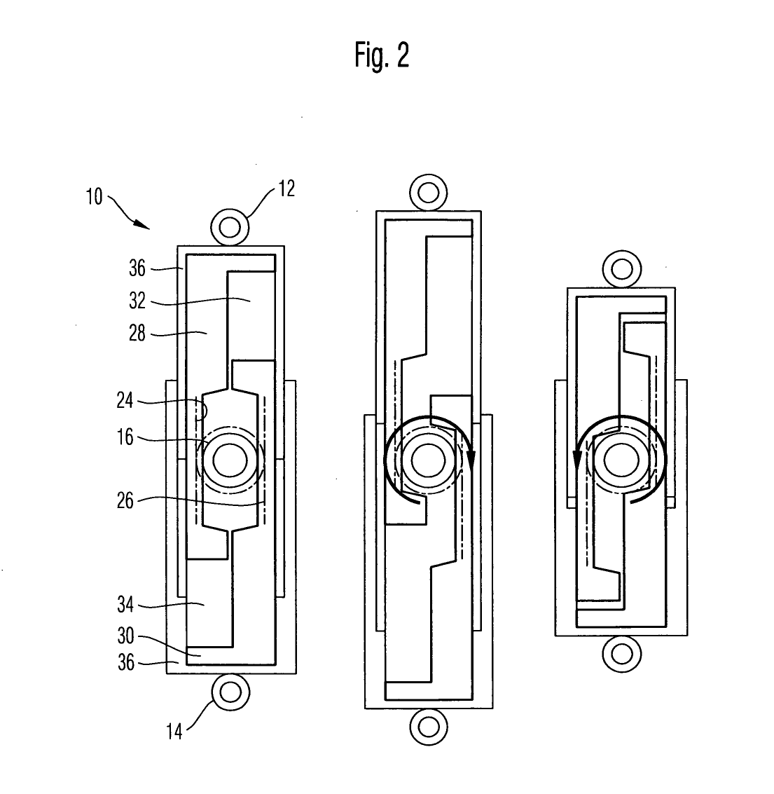

In FIG. 2 an actuator 10 is shown. The drive pinion 16 engages in two toothed racks 24, 26 which are part of a tappet 28 and 30, respectively. The two tappets are telescopically mounted; the tappet 30 slides into a mount 32 of the tappet 28 and the tappet 28 slides into a mount 34 of the tappet 30. Additionally, covering parts 36 are provided.

When, starting from the initial position shown in the left-hand representation of FIG. 2, the pinion 16 is rotated in a clockwise direction, the two tappets 28, 30 are pushed apart, which results in a state shown in FIG. 2 in the representation in the middle, in which the two fastening eyes 12, 14 are pushed apart. When the drive pinion 16 is rotated in the opposite direction, the distance between the two fastening eyes 12, 14 becomes shorter (see the right-hand representation in FIG. 2).

In this manner there is created a linear actuator enabling a comparatively large stroke, while having a small construction space.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. An actuator, in particular for an active chassis of a motor vehicle, comprising a first and a second toothed rack and a pinion which engages in the first and second toothed racks and is adapted to move the first and second toothed racks in directions opposite to one another.

2. The actuator according to claim 1, wherein one of the first and second toothed racks is displaceably received in the other one of the first and second toothed racks.

3. The actuator according to claim 1, wherein the first and second toothed racks are displaceable parallel to one another.

4. The actuator according to claim 1, wherein there is provided a drive motor which is arranged separately from the actuator and is connected to the actuator via a drive shaft.

5. The actuator according to claim 4, wherein the drive shaft is a propeller shaft.

6. The actuator according to claim 4, wherein the drive shaft is a flexible shaft.

7. The actuator according to claim 6, wherein the flexible shaft is a Bowden cable.
